(19) United States
(12) Patent Application Publication
(10) Pub. No.: US 2017/0116600 A1
(43) Pub. Date: Apr. 27, 2017

(54) Method and System for Performing Commercial Transactions Relating to or Purchased From a Vehicle

(71) Applicant: MASTERCARD INTERNATIONAL INCORPORATED, Purchase, NY (US)

(72) Inventor: Ashutosh Sharan, Gurgaon (IN)

(21) Appl. No.: 15/334,716

(22) Filed: Oct. 26, 2016

(30) Foreign Application Priority Data
Oct. 27, 2015 (SG) 10201508868R

(51) Int. Cl. G06Q 20/36; G06Q 20/40; G06Q 20/10

(52) U.S. Cl. CPC G06Q 20/3674; G06Q 20/102; G06Q 20/40145; G06Q 20/4012; G06Q 2240/00

(57) ABSTRACT

A computer-implemented method is proposed for performing commercial transactions relating to or purchased from a vehicle. The method comprises: a merchant server identifying a vehicle in relation to which the transaction is to be performed and a digital wallet associated with the vehicle and sending a payment request to a wallet service associated with the digital wallet; the merchant server receiving authentication of the payment request from the wallet service and details of a user-specified payment mechanism stored in the digital wallet; and the merchant server transmitting the details of the payment mechanism along with details of the transaction to a payment network to complete the transaction.

### CROSS-REFERENCE TO RELATED APPLICATION

This application claims the benefit of and priority to Singapore Patent Application No. 10201508868R, filed Oct. 27, 2015. The entire disclosure of the above application is incorporated herein by reference.

### FIELD

The present disclosure generally relates to a method and system for performing commercial transactions relating to or purchased from a vehicle.

### BACKGROUND

This section provides background information related to the present disclosure which is not necessarily prior art.

Many commercial transactions relating to vehicles take place. For example, the purchasing of fuel, parking charges, toll charges, car insurance, car servicing and speeding and parking infringements. In addition, with the advent of internet-enabled vehicles other goods/service may be purchased from a car such as on-demand car entertainment or in-car concierge services (including, for example, restaurant booking, gift ordering and purchasing of entertainment tickets).

There is therefore a need to provide an improved method and system for performing commercial transactions relating to or purchased from a vehicle.

### SUMMARY

This section provides a general summary of the disclosure, and is not a comprehensive disclosure of its full scope or all of its features. Aspects and embodiments of the disclosure are also set out in the accompanying claims.

In accordance with a first aspect of the disclosure there is provided a computer-implemented method for performing commercial transactions relating to or purchased from a vehicle comprising:
a) a merchant server identifying a vehicle in relation to which the transaction is to be performed;
b) the merchant server identifying a digital wallet associated with the vehicle;
c) the merchant server sending a payment request to a wallet service associated with the digital wallet;
d) the merchant server receiving authentication of the payment request from the wallet service;
e) the merchant server receiving details of a user-specified payment mechanism stored in the digital wallet; and
f) the merchant server transmitting the details of the payment mechanism along with details of the transaction to a payment network to complete the transaction.

Embodiments of the present disclosure have the advantage that payment can be requested directly from a vehicle's associated wallet, without the merchant having to know details of the vehicle owner in order to invoice for the charges incurred. All the merchant needs to do is to identify the vehicle (e.g. by way of a vehicle registration number). It is believed that embodiments of the disclosure will significantly simplify and accelerate the processing of commercial transactions relating to or purchased from a vehicle as they can be requested electronically in a quick and easy manner at the time the charges are incurred. Conveniently, embodiments of the disclosure can facilitate all transactions between a vehicle-owner and vehicle-related goods/services.

The wallet service could be a server-side wallet (i.e. set up by the merchant) or a client-side wallet (i.e. set up by the user).

Step f) may be carried out in the form of a business-as-usual transaction whereby the merchant server sends an authorisation request to the payment network via a payment gateway. An acquirer then processes the request and transmits it to an issuer bank associated with the payment mechanism. Once approved by the issuer bank, the payment is transferred to the acquirer for storing in the merchant account.

The payment request may relate to one or more of the following: fuel, parking charges, toll charges, vehicle insurance, vehicle servicing, speeding and parking infringements (or other Police-administered fines); in-vehicle entertainment; and in-vehicle concierge services (including, for example, restaurant booking, gift ordering and purchasing of entertainment tickets).

The vehicle may be identified by one or more of: a vehicle registration number/code; vehicle make and model; year of vehicle registration; vehicle owner details (e.g. name and/or address).

The digital wallet may be configured to receive pre-paid funds (e.g. from an owner's bank account). In this way, the owner may select an amount to pay into the digital wallet (e.g. on an ad hoc, daily, weekly, monthly, quarterly or annual basis). It is believed that such a system will carry less risk of unauthorised transactions than if the wallet was linked directly to the owner's bank account or credit card, for example, if the vehicle and/or digital wallet were stolen. However, in some embodiments, the digital wallet may be linked to another type of payment mechanism such as a credit card or debit card.

As used in this document, the term “payment card” or “payment mechanism” refers to any suitable cashless payment device, such as a credit card, a debit card, a prepaid card, a charge card, a membership card, a promotional card, a frequent flyer card, an identification card, a gift card, and/or any other device that may hold payment account information, such as mobile phones, Smartphones, personal digital assistants (PDAs), key fobs, transponder devices, NFC-enabled devices, tablets and/or computers.

The digital wallet may be stored in the vehicle. For example, a device may be provided in the vehicle, incorporated into the vehicle as a part thereof or fitted thereto (either on manufacture or during a retro-fit), which comprises the digital wallet associated with the vehicle.

In some embodiments, the digital wallet may alternatively or additionally, be stored on a remote (e.g. cloud) server and accessed via the internet.

The vehicle may be constituted by a car, van, truck, bus, caravan, motorhome, motorbike, bicycle, boat, train, aeroplane, helicopter or other vehicle.

The vehicle may be internet-enabled (i.e. capable of communication over the internet).

In some embodiments, the vehicle may comprise a wireless communication device (e.g. a near-field communication (NFC) device) for communication with a co-operating merchant device. In this way, communication between the vehicle's digital wallet and the merchant server may be direct or through a local area network (LAN) as opposed to over the internet. Such a system may be advantageous for purchases at a fuel station, parking lot or toll gate as well as on-the-spot fines charged by Police officers.

The merchant server may identify the vehicle by any suitable means. For example, the merchant server may identify the vehicle from a database (e.g. in the case of vehicle insurance/servicing companies) or GUI (e.g. for data input by Police officers). In other embodiments, the vehicle may be identified by an optical/electronic reader (e.g. that reads a vehicle registration from a video feed or that scans a vehicle barcode). In some embodiments, a detector may be used to detect an electronic signal emitted from a vehicle transmitter (e.g. a NFC device such as an RFID tag provided on the vehicle).

More specifically, when a vehicle enters an area such as a fuel station, the vehicle registration number may be read electronically as soon as the car enters the area. In other embodiments, a handheld mobile device may be used to initiate a payment (e.g. to request payment for a police ticket the police could have a device to initiate payment from the digital wallet via the internet or a NFC device). Furthermore, service providers (e.g. insurance providers) could bill the vehicle's digital wallet directly over the internet using just the vehicle identification.

The merchant server will therefore identify the vehicle and send a payment request to the digital wallet associated with the vehicle.

When the payment request is received by the digital wallet, an authentication process is initiated.

The authentication process may comprise seeking approval of the requested payment from a user of the digital wallet. The user may be the owner of the digital wallet and/or the owner of the vehicle. In some embodiments, the user may be authorised (by the owner of the wallet/vehicle) to make payments from the digital wallet.

Approval of the requested payment may be made through a GUI (e.g. on the vehicle or through a smartphone, tablet or computer). The GUI may comprise voice recognition or a retina or fingerprint scan. In other embodiments, a password or PIN may be required to approve the payment.

If the approval is granted (i.e. if the user's voice, retina, fingerprint, password or PIN sufficiently matches that stored in the digital wallet and/or in an authentication database), the payment request is authorised and the funds subsequently transferred to the merchant.

In some embodiments, the authentication process may comprise checking whether the user wishes to proceed with the transaction or not. For example, in the case of vehicle insurance, the user may decide to change to a different provider and therefore not accept a payment request from their previous provider.

One or more of the steps in the method may require internet communication to/from the vehicle. If the vehicle is not connected to the internet (e.g. because it is out of range) at the time that a step is to be performed, data associated with the step may be stored in a buffer for subsequent communication when the vehicle is connected to the internet.

In accordance with a second aspect of the disclosure there is provided a computer system for performing commercial transactions relating to or purchased from a vehicle comprising a processor configured for:
a) identifying a vehicle in relation to which the transaction is to be performed;
b) identifying a digital wallet associated with the vehicle;
c) sending a payment request to a wallet service associated with the digital wallet;
d) receiving authentication of the payment request from the wallet service;
e) receiving details of a user-specified payment mechanism stored in the digital wallet; and
f) transmitting the details of the payment mechanism along with details of the transaction to a payment network to complete the transaction.

The system may further comprise one or more of: a database of vehicle identities; a GUI for a merchant to input a vehicle identity; an optical/electronic reader for identifying a vehicle; or a detector for identifying a vehicle.

The system may further comprise an authentication engine for authenticating the payment request. The authentication engine may be configured to seek approval of the requested payment from a user of the digital wallet; to receive an input from the user; and to verify that the input matches that stored in the digital wallet and/or in an authentication database. The input may comprise the user's voice, retina, fingerprint, password or PIN. The system may therefore further comprise an input device in the form of a GUI (which may comprise a voice recognition device or a retina or fingerprint scanner).

The disclosure may be implemented in the form of a centralised computer system (e.g. a merchant server) which presents an interface to which users and merchants may connect (e.g. over the internet).

The optional method features described above may be implemented using the computer system according to the second aspect of the disclosure.

In accordance with a third aspect of the disclosure there is provided a non-transitory computer-readable medium having stored thereon program instructions for causing at least one processor to perform the method according to the first aspect of the disclosure.

In accordance with a fourth aspect of the disclosure there is provided a device comprising a memory having stored therein a digital wallet associated with a vehicle for performing commercial transactions relating to or purchased from the vehicle. The device may be provided in the vehicle and/or located remotely (e.g. as a remote server) that can be connected to over the internet.

In accordance with a fourth aspect of the disclosure there is provided a vehicle comprising the device according to the fourth aspect of the disclosure.

Further areas of applicability will become apparent from the description provided herein. The description and specific examples and embodiments in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure. With that said, embodiments of the disclosure will now be described, by way of example only, with reference to the following drawings, in which:

FIG. 1 is a flowchart of a computer-implemented method according to an embodiment of the present disclosure; and

FIG. 2 is a block diagram of a computer system according to an embodiment of the present disclosure.

Corresponding reference numerals generally indicate corresponding parts throughout the several views of the drawings.

### DETAILED DESCRIPTION

Embodiments of the present disclosure will be described, by way of example only, with reference to the drawings. The description and specific examples included herein are intended for purposes of illustration only and are not intended to limit the scope of the present disclosure.

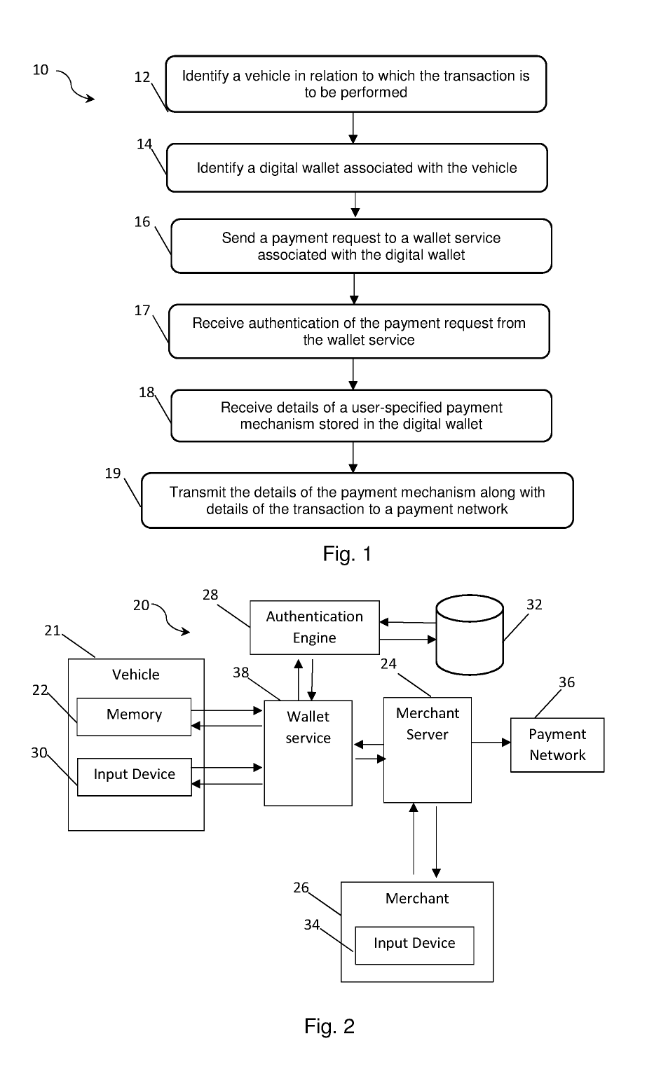

In accordance with an embodiment of the present disclosure there is provided a computer-implemented method 10 for performing commercial transactions relating to or purchased from a vehicle, as illustrated in FIG. 1. In particular, the method comprises a merchant server carrying out the following steps:

Step 12: identify a vehicle in relation to which the transaction is to be performed;

Step 14: identify a digital wallet associated with the vehicle;

Step 16: send a payment request to a wallet service associated with the digital wallet;

Step 17: receive authentication of the payment request from the wallet service;

Step 18: receive details of a user-specified payment mechanism stored in the digital wallet; and

Step 19: transmit the details of the payment mechanism along with details of the transaction to a payment network to complete the transaction.

FIG. 2 shows a block diagram of a computer system 20 according to an embodiment of the present disclosure. The computer system 20 is configured for performing commercial transactions relating to or purchased from a vehicle 21, in accordance with the method described above, and comprises a device including a memory 22 and a merchant server 24. The memory 22 has a digital wallet associated with a vehicle 21 stored thereon while the merchant server 24 is configured for: identifying the vehicle 21 in relation to which the transaction is to be performed; identifying a digital wallet associated with the vehicle 21; sending a payment request to a wallet service 38 associated with the digital wallet; receiving authentication of the payment request from the wallet service 38; receiving details of a user-specified payment mechanism stored in the digital wallet; and transmitting the details of the payment mechanism along with details of the transaction to a payment network 36 to complete the transaction.

More specifically, after the vehicle 21 has been identified, the merchant server 24 may identify the digital wallet associated with the vehicle 21 by looking up the vehicle information in a database. Alternatively, the merchant server 24 may communicate directly with the vehicle 21 to determine details of the digital wallet. For example, the wallet may be incorporated into a device that transmits a near field communication (NFC) signal identifying itself and the server 24 may be connected to an input device configured to receive such a signal and transmit details of the wallet to the server 24. The server 24 may then transmit a signal to a digital wallet service 38 associated with the wallet. The digital wallet service 38 may be provided at the client-side (e.g. as an application installed in the vehicle 21) such that it can be communicated with via NFC or it may be provided at a wallet server-side and communicated with via the internet.

The system further includes an authentication engine 28, operated by the wallet service 38 for authenticating the payment request by seeking approval of the requested payment from a user of the digital wallet, receiving an input from the user through an authentication input device 30 and verifying that the input matches that stored in an authentication database 32.

In this case, the authentication input device 30 is in the form of a GUI configured for a user to input their voice through a voice recognition module. However, in other embodiments the user may authenticate a transaction by scanning their retina or fingerprint or by inputting a password or PIN.

Furthermore, in the present embodiment, a merchant input device 34 is provided in the form of an optical reader configured to identify the vehicle 21 so that payment can be requested from the associated digital wallet. In other embodiments, the merchant input device 34 may be in the form of a database of vehicle identities; a GUI for a merchant 26 to input a vehicle identity; or a detector configured to identify a vehicle (e.g. from an RFID tag in the vehicle).

Although not shown, the computer system 20 may further comprise a GUI for presenting information to an operator. Furthermore, the computer system 20 may comprise a distributed system with one or more components (e.g. databases) distributed over a network (e.g. the internet). Alternatively, the computer system 20 may comprise a personal computer (PC) or a mobile device, such as a tablet computer or a smartphone.

In the present embodiment, the payment request may arise from a fuel station which identifies the vehicle 21 by scanning its registration plate as it enters the fuel station. The fuel pump will then register the amount of fuel consumption and the associated cost and will make a payment request accordingly to the vehicle's digital wallet which is stored in the vehicle's memory 22. The user (i.e. driver) will then be asked to authenticate the payment using the voice recognition input device 30 in the vehicle 21. The authentication engine 28 will check that the user's voice matches that in the authentication database 32 before permitting the payment to be made from a user-identified payment mechanism stored in the digital wallet to the merchant 26 (i.e. fuel station). In this case, the digital wallet is pre-paid with funds from the user's bank account and the transaction will proceed as long as there are sufficient funds to cover the payment.

For completeness, it should be understood that, once authorised, the transaction will be completed a standard way. For example, the merchant server will send a transaction request to the payment network 36 via a payment gateway. An acquirer will then process the request and transmit it to an issuer bank associated with the payment mechanism identified in the transaction request. Once approved by the issuer bank, the payment will be transferred to the acquirer for storing in the merchant account.

As explained above, embodiments of the present disclosure have the advantage that commercial transactions relating to or purchased from a vehicle 21 can quickly and easily be initiated by the merchant 26 identifying the vehicle 21 and sending a payment request to the vehicle's digital wallet. However, for security purposes the transaction will only be completed if the user of the digital wallet authorises the payment and this is verified by the system 20.

Although only a single system and method according to embodiments of the present disclosure have been described in detail, many variations are possible in accordance with the appended claims.

With that said, it should be appreciated that one or more aspects of the present disclosure transform a general-purpose computing device into a special-purpose computing device when configured to perform the functions, methods, and/or processes described herein.

In addition, the terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

Again, the foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for performing commercial transactions relating to, or purchased from, a vehicle, the method comprising:
identifying, by a merchant server, a vehicle in relation to which the transaction is to be performed;
identifying, by the merchant server, a digital wallet associated with the vehicle;
sending, by the merchant server, a payment request to a wallet service associated with the digital wallet;
receiving, by the merchant server, authentication of the payment request from the wallet service;
receiving, by the merchant server, details of a user-specified payment mechanism stored in the digital wallet; and
transmitting, by the merchant server, the details of the payment mechanism along with details of the transaction to a payment network to complete the transaction.

2. The method according to claim 1, wherein the payment request relates to one or more of the following: fuel, parking charges, toll charges, vehicle insurance, vehicle servicing, speeding infringements, parking infringements; other Police-administered fines; in-vehicle entertainment; and in-vehicle concierge services; and
wherein the vehicle is identified by one or more of: a vehicle registration number/code; vehicle make and model; year of vehicle registration; vehicle owner details.

3. (canceled)

4. The method according to claim 1, wherein the digital wallet is configured to receive pre-paid funds; and/or
wherein the digital wallet is linked to at least one payment mechanism.

5. (canceled)

6. The method according to claim 1, wherein the digital wallet is stored in the vehicle.

7. (canceled)

8. (canceled)

9. The method according to claim 1, wherein the vehicle is constituted by a car, van, truck, bus, caravan, motorhome, motorbike, bicycle, boat, train, aeroplane or helicopter.

10. The method according to claim 1, wherein the vehicle is internet-enabled.

11. The method according to claim 1, wherein the vehicle comprises a wireless communication device for communication with a co-operating merchant device; and/or
wherein the merchant server identifies the vehicle from a database; a GUI; an optical/electronic reader or a detector.

12. (canceled)

13. The method according to claim 1, wherein the step of authenticating the payment request comprises seeking approval of the requested payment from a user of the digital wallet.

14. The method according to claim 13, wherein approval of the requested payment is made by user input through a GUI.

15. The method according to claim 14, wherein the GUI comprises voice recognition or a retina or fingerprint scan; and/or
wherein the user input includes a password or PIN.

16. (canceled)

17. The method according to claim 14, wherein the user input is compared to a reference input stored in the digital wallet and/or in an authentication database and the payment request is authorised when the user input and the reference input are deemed to match.

18. (canceled)

19. The method according to claim 1, wherein if the vehicle is not connected to the internet at the time that one or more of the method steps are to be performed, data associated with the step(s) is stored in a buffer for subsequent communication when the vehicle is connected to the internet.

20. A computer system for performing commercial transactions relating to, or purchased from, a vehicle, the system comprising a merchant server configured to:
identify a vehicle in relation to which the transaction is to be performed;
identify a digital wallet associated with the vehicle;
send a payment request to a wallet service associated with the digital wallet;
receive authentication of the payment request from the wallet service;
receive details of a user-specified payment mechanism stored in the digital wallet; and
transmit the details of the payment mechanism along with details of the transaction to a payment network to complete the transaction.

21. The system according to claim 20, further comprising a merchant server input device in the form of one or more of: a database of vehicle identities; a GUI for a merchant to input a vehicle identity; an optical/electronic reader for identifying a vehicle; or a detector for identifying a vehicle.

22. The system according to claim 20, further comprising an authentication engine for authenticating the payment request.

23. The system according to claim 22, wherein the authentication engine is configured to seek approval of the requested payment from a user of the digital wallet; to receive an input from the user; and to verify that the input matches that stored in the digital wallet and/or in an authentication database.

24. The system according to claim 23, further comprising an authentication input device in the form of a GUI.

25. The system according to claim 24, wherein the GUI is configured for a user to input their voice, scan their retina or fingerprint or input a password or PIN.

26. (canceled)

27. A device comprising a memory having stored therein a digital wallet associated with a vehicle for performing commercial transactions relating to or purchased from the vehicle.

28. A vehicle comprising the device according to claim 27.
